(19) United States
(12) Patent Application Publication
(10) Pub. No.: US 2020/0001208 A1
(43) Pub. Date: Jan. 2, 2020

(54) Process and System for Treating Waste Water

(71) Applicant: Kytolink Tech Pte., Ltd., Singapore (SG)

(72) Inventors: Qingzhong Wang, Kunming City (CN); Lian Chuan Lim, Singapore (SG); Zhong Li, Singapore (SG)

(73) Assignee: Kytolink Tech Pte. Ltd., Singapore (SG)

(21) Appl. No.: 15/774,566

(22) PCT Filed: Nov. 7, 2016
(86) PCT No.: PCT/SG2016/050550

§ 371 Date: May 8, 2018

(30) Foreign Application Priority Data
Nov. 11, 2015 (SG) 10201509295U

(51) Int. Cl. B01D 21/00; B01D 21/06; B01D 21/24; B01J 20/04

(52) U.S. Cl. CPC B01D 21/0045; B01D 21/06; B01J 20/14; B01J 20/041; B01D 21/2444

(57) ABSTRACT

The present invention relates to a waste water treatment process and system for treatment of waste water utilizing a diatomite treatment agent containing about 98 to 99.9% by weight of diatomite particles, wherein the diatomite particles comprise unbalanced surface charges and is substantially free of counter ions being electrostatically coupled to the unbalanced surface charges, and wherein the diatomite treatment agent is obtained from the disclosed pre-treatment process. This diatomite treatment agent has posed several advantages in a waste water treatment process, particularly acting as a biomass carrier, physical coagulant and adsorbent in a system for treatment of waste water, the system comprising a specially designed clarifier.

### TECHNICAL FIELD

The present invention generally relates to waste water treatment processes and systems, involving diatomite obtained from a novel diatomite beneficiation process.

### BACKGROUND ART

Waste water treatment refers to the reduction and removal of suspended solids, organic matters and nutrients from process wastewater and domestic sewage via physical, biological and chemical means, so as to reduce waste water pollution of the environment or to reuse treated waste water.

Conventional secondary waste water treatment processes may require the use of multiple bioreactors for reducing BOD, phosphorus and nitrogen content in the waste water. This in turn results in a large footprint due to the number and size of process equipment used. In addition, providing multiple reaction stages and reactors may also mean that the hydraulic retention time is comparatively longer in order to achieve the same rate of water treatment. Conventional waste water treatment processes may also be prone to sludge bulking and floating problems, thereby resulting in poor effluent quality. Moreover, the use of flocculants or coagulants to aggregate waste sludge e.g., during dewatering processes, may result in secondary pollution; and may also cause bad odor emission during plant operation.

Diatomaceous earth (diatomite) has been used in the treatment of wastewater as filter aids. Diatomaceous earth consists of silica skeletons of diatoms, which are unicellular organisms of either lacustrine or marine origin. The skeletons comprise opal-like, amorphous silica (SiO₂.H₂O) comprising small amounts of microcrystalline materials. The intricate and porous structure unique to diatomaceous earth may be effective for the physical entrapment of particles in filtration processes, such as in waste water treatment.

However, diatomaceous earth is usually contaminated with varying quantities of clay, quartz, other minerals, and organic materials. Thus, raw diatomaceous earth usually contains a low amount of diatom cells. The adsorption capability of raw diatomaceous earth is therefore limited. As a result, high dosages of diatomaceous earth are required for effective waste water treatment.

In some instances, a refined version of diatomite is used for waste water treatment. Refined diatomite is typically processed from crude diatomite via known beneficiation processes to achieve a relatively high degree of purity, e.g., greater than 80% diatomite by weight. However, additional flocculants and/or additional coagulants must still be used in concert with refined diatomite in order to achieve satisfactory results of waste water treatment or for satisfactory recovery of the sludge during dehydration/dewatering processes.

Commonly used coagulants include metal-based coagulants, such as aluminium or iron sulphate, hydrated lime and magnesium carbonate. Commonly used flocculants include polyacrylamide. Such treatment processes remain less than ideal because even small, residual amounts of coagulant and flocculant remaining in the effluent after post-treatment may result in secondary contamination.

Accordingly, there is a need to provide a process or system to treat waste water that overcomes, or at least ameliorates, one or more of the disadvantages described above.

### SUMMARY OF INVENTION

The present disclosure provides a waste water treatment process comprising the steps of: a) contacting microbes with a waste water stream to form a mixed liquor stream comprising activated sludge; b) dosing said mixed liquor stream with at least one diatomite treatment agent; c) separating water from said mixed liquor stream to thereby provide a treated waste water effluent; and wherein said diatomite treatment agent comprises at least 90 to 99.9% of purified diatomite, wherein the purified diatomite comprises unbalanced surface charges. In particular, the diatomite cells of the purified diatomite may be substantially free of counter ions electrostatically coupled to its surface. More particularly, the diatomite cell may comprise a plurality of pores having an interior pore surface, and wherein the interior pore surface is substantially free of counter ions or charged impurities being electrostatically coupled thereto. Advantageously, the purified diatomite expresses a higher degree of unbalanced surface potential relative to crude (naturally occurring) diatomite.

According to one aspect of the present disclosure, there is provided a waste water treatment process comprising the steps of: a) contacting microbes with a waste water stream to form a mixed liquor stream comprising activated sludge; b) dosing said mixed liquor stream with at least one diatomite treatment agent; c) separating water from said mixed liquor stream to thereby provide a treated waste water effluent; and wherein said diatomite treatment agent comprises 98 to 99.9% by weight of diatomite particles, said diatomite particles comprising unbalanced surface charges, and wherein said diatomite treatment agent is obtained from a pre-treatment process comprising: contacting crude diatomite with a treatment solution to form a slurry, the treatment solution comprising, based on the weight of the crude diatomite, about 0.03-0.05 wt. % of at least one xanthine derivative, about 0.1-0.2 wt. % of at least one metal metasilicate, about 0.025-0.05 wt. % of at least one metal phosphate, about 0.01-0.025 wt. % of at least one base and about 0.015-0.035 wt. % of at least one metal carbonate.

The purified diatomite may consist essentially of siliceous frustules of diatomite cells that have been pre-treated to improve its purity and to increase its unbalanced surface charges. Hence, the terms “purified diatomite” and “pre-treated diatomite” are used interchangeably herein.

In the present disclosure, the transitional expression “consists essentially of” or its variants thereof, when used to describe the disclosed diatomite treatment agent means that the diatomite treatment agent may consist solely of diatomite or may optionally comprise in addition to purified diatomite, other component(s) or material(s) that do not materially affect the characteristics and performance of the diatomite treatment agent.

In particular embodiments, the disclosed process advantageously excludes the addition of a flocculant or a coagulant to the waste water, the mixed liquor stream, the activated sludge or the discharged/recycled sludge. The diatomite treatment agent may be substantially free of any flocculant or coagulant and may be added solely into the activated sludge or the mixed liquor stream that has undergone or undergoing biological treatment.

The diatomite agent may be substantially free or completely free of silica that is not of diatomite origin, e.g., silica sand or clay-based silica.

The disclosed diatomite treatment agent may also be substantially free or completely free of clay minerals, which are normally present as impurities in crude diatomite or even in refined diatomite that has not been pre-treated in accordance with processes disclosed herein.

In some embodiments, the purified diatomite has been pre-treated under suitable conditions to increase its net unbalanced charge relative to crude or refined diatomite that has not been pre-treated in accordance with processes disclosed herein. In embodiments, the pre-treatment may increase the density of surface charges present on the surface and pores of the diatomite cells that are not balanced with an oppositely charged counter ion.

For instance, both the external and interior pore surfaces of the purified diatomite may be substantially free of metal cations (e.g., Na⁺, Mg²⁺, Zn²⁺) or other charged impurities that may have been electrostatically coupled to the diatomite cells prior to the pre-treatment.

Advantageously, the pre-treated diatomite treatment agent may be capable of adsorbing the microbes after their use in the waste water treatment process and may also be capable of adsorbing undesirable matters in waste water. Accordingly, the diatomite treatment agent may advantageously act as a biomass carrier, physical coagulant and adsorbent.

Advantageously, it has been found that the pre-treated diatomite results in superior adsorptive properties and the diatomite treatment agent is capable of providing effective waste water treatment even in doses or amounts of less than 50 milligrams per litre of mixed liquor stream. In other embodiments, effective waste water treatment can be achieved at doses of from 10 to 30 mg/L of mixed liquor stream. By “effective waste water treatment”, it is intended to mean that the waste water, after treatment and being recovered from the mixed liquor stream, has its Chemical Oxygen Demand (COD) reduced by at least from 80% to 99.9% relative to the incoming waste water stream or influent, or that nitrogen content has been reduced by at least 80% to 99.9% relative to the influent, or that phosphorus content has been reduced by at least 92% to about 99.9% relative to the influent, or that metal impurities (e.g., copper, zinc, lead, cadmium, chromium) have been reduced by at least 91% to about 99.9% relative to the influent, or any one or more of the performance indicators described above.

As a result, the disclosed waste water treatment process may be substantially streamlined compared to existing processes. For instance, the disclosed process may not require an anaerobic stage or is able to substantially reduce the residence time of an anaerobic treatment stage. The disclosed process may also not require the use of PAOs (polyphosphate accumulating organisms). This is because the purified diatomite may provide sufficient phosphorus removal. This means that the biological treatment process may be simplified and lesser bio-reactors or tanks are required.

Also advantageously, the disclosed process may be able to substantially reduce the residence time of an anoxic treatment stage due to improved nitrogen removal by the purified diatomite.

The disclosed process may also shorten the time required for biological treatment, e.g., the disclosed process may shorten hydraulic residence time at an anoxic or aerobic stage of the disclosed process.

The disclosed process may reduce plant footprint due to improved separation and treatment efficiency.

The disclosed process may reduce costs as the amount of diatomite treatment agent required for effective waste water treatment is significantly reduced compared to known processes.

Another advantage of the disclosed diatomite treatment agent is that it improves concentration and porosity of the sludge, thereby facilitating ease of dehydration or dewatering of the sludge e.g., in a filter press. Surprisingly, the use of the disclosed diatomite treatment agent negates the need to add a coagulant to the discharged/waste activated sludge, which is normally essential in current sludge dewatering or dehydration procedures.

The present disclosure also provides a system for treatment of waste water, the system comprising: at least one biological treatment zone configured to receive and contact waste water influent with microbes to thereby form a mixed liquor stream comprising activated sludge; a clarifier in fluid communication with said biological treatment zone and configured to receive said mixed liquor stream from said biological treatment zone; an inlet means disposed upstream of said clarifier operable to introduce a diatomite treatment agent to said mixed liquor stream; wherein said diatomite treatment agent comprises at least 90 to 99.9% of purified diatomite, wherein the purified diatomite comprises unbalanced surface charges; and an outlet means extending from said clarifier, being configured to discharge water that has been separated from the mixed liquor stream as treated waste water effluent.

According to another aspect of the present disclosure, there is provided a system for treatment of waste water, the system comprising: at least one biological treatment zone configured to receive and contact waste water influent with microbes to thereby form a mixed liquor stream comprising activated sludge; a clarifier in fluid communication with said biological treatment zone and configured to receive said mixed liquor stream from said biological treatment zone; an inlet means disposed upstream of said clarifier operable to introduce a diatomite treatment agent to said mixed liquor stream; wherein said diatomite treatment agent comprises 98 to 99.9% by weight of diatomite particles, said diatomite particles comprising unbalanced surface charges, and wherein said diatomite treatment agent is obtained from a pre-treatment process comprising: contacting crude diatomite with a treatment solution to form a slurry, the treatment solution comprising, based on the weight of the crude diatomite, about 0.03-0.05 wt. % of at least one xanthine derivative, about 0.1-0.2 wt. % of at least one metal metasilicate, about 0.025-0.05 wt. % of at least one metal phosphate, about 0.01-0.025 wt. % of at least one base and about 0.015-0.035 wt. % of at least one metal carbonate; and an outlet means extending from said clarifier, being configured to discharge water that has been separated from the mixed liquor stream as treated waste water effluent.

In embodiments, the waste water treatment system employs a diatomite agent that has been pre-treated or purified in accordance with pre-treatment processes as disclosed herein.

### Definitions

The following words and terms used herein shall have the meaning indicated:

The term “diatomite” as used herein refers to fossilized remains of diatom microorganisms. Diatom cells are enclosed within a porous cell wall, or “frustule”, composed of silica. Upon death, the organic material of diatom cells decomposes, leaving behind the frustules. Diatomite includes various diatom species that may occur in a wide variety of shapes, such as cylindrical, rod-like, and star-shaped. The terms “diatomaceous earth”, “diatomite” and “diatom” are used interchangeably herein.

The term “purified diatomite” as used herein refers to diatomite that has been pre-treated according to methods/processes disclosed herein to achieve superior adsorptive properties relative to crude or refined diatomite that has not been pre-treated similarly. Purified diatomite may refer to pre-treated diatomite expressing a greater unbalanced potential/unbalanced charge on its surface relative to diatomite that has not been pre-treated in accordance with the present disclosure.

The term “net charge” as used herein in reference to the charge of a compound means that there is an imbalance in the number of active groups within the compound having a charge, i.e. either a positive or negative charge, and the number of active groups within the compound having the opposite charge. The higher number of active groups having a certain charge therefore confers a net charge onto the compound. A compound having a “net positive charge” means that the compound has a higher number of active groups having a positive charge than active groups having a negative charge. Similarly, a compound having a “net negative charge” means that the compound has a higher number of active groups having a negative charge than active groups having a positive charge.

The terms “clay” or “clay minerals” or “clay-based minerals” as used herein refers to naturally occurring material composed primarily of phyllosilicate minerals, which is generally plastic at appropriate water contents and will harden when dried or fired. Although clay usually contains phyllosilicates, it also may contain other materials that impart plasticity and harden when dried or fired. Associated phases in clay may include materials that do not impart plasticity and organic matter. See generally, Guggenheim, S. & Martin, R. T., “Definition of Clay and Clay Mineral: Joint Report of the AIPEA Nomenclature and CMS Nomenclature Committees,” Clays and Clay Minerals 43: 255-256 (1995).

The term “activated” as used herein in reference to sludge refers to the mixture of suspended solids, bacteria and other microorganisms in a biological treatment zone that are generated or cultivated during biological treatment of waste water and that utilize organic and inorganic chemicals in the waste water as sources of nutrients and energy for growth, to thereby remove the chemicals from the waste water. “Activated sludge” encompasses return activated sludge (RAS).

The term “mixed liquor stream” as used herein refers to a stream comprising waste water (influent waste water, recycled waste water or otherwise), activated sludge, microbes, suspended solids and other matter from the biological treatment.

The term “aerobic” as used in reference to biological treatment is to be interpreted generally to refer to an environment where dissolved oxygen is available. Aerobic treatment involves the use of microorganisms that derive their oxygen requirements from dissolved oxygen.

The term “anoxic” as used in reference to biological treatment is to be interpreted generally to refer to an environment where very little dissolved oxygen (“DO”) is available. Anoxic treatment involves the use of microorganisms that derive their oxygen requirements from chemically combined oxygen such as that found in nitrite and nitrate.

The term “anaerobic” as used in reference to biological treatment is to be interpreted generally to refer to the absence of dissolved oxygen in an environment.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of methods for obtaining the diatomite treatment agent for use in the disclosed waste water treatment process and system shall now be disclosed.

The diatomite agent used in the disclosed method may be obtained from a pre-treatment process comprising a step of contacting crude diatomite with a treatment solution comprising at least one xanthine derivative, at least one metal silicate or metal phosphate, at least one metal hydroxide and at least one metal carbonate to form a slurry; and separating diatomite cells from said slurry by gravitational separation to form said diatomite treatment agent. Advantageously, the treatment solution may provide or enhance the differences in settling rate between diatomite cells and other impurities present in crude diatomite e.g., quartz, sand, clay-type matter and impurities during the separation step, thereby improving the effectiveness of separation and the purity of diatomite obtained therefrom. The pre-treatment process may further comprise subjecting the slurry to sonication prior to, before and/or during separation. The pre-treatment process may also comprise applying an electric field to said slurry prior to, before and/or during separation.

In embodiments, the pre-treatment of the purified diatomite may be a beneficiation method comprising: mixing crude diatomite with a treatment solution to thereby form a slurry; removing coarse particulate impurities exceeding 150 microns in size from the slurry; sonicating the slurry; removing fine particulate impurities exceeding 20 microns in size from said slurry; applying an electrostatic field to said slurry; and subjecting said slurry to gravitational separation to obtain purified diatomite particles having a particle size of between about 10 microns to about 200 microns.

The diatomite treatment agent may be derived from a naturally occurring source. The diatomite treatment agent may be prepared from crude diatomite rock or raw diatomaceous earth. The crude diatomite may be mined from ore or otherwise obtained.

The composition of the crude diatomite may vary depending on the location it is obtained from. The composition of the crude diatomite may vary depending on the type of deposit of diatom species. In one example, the chemical composition of crude diatomite comprises 60-62 wt. % of SiO₂, 19-21 wt. % of Al₂O₃, and 8-11 wt. % of Fe₂O₃; and comprises the following ingredients: 45 wt. % of quartz sand and detrital minerals, 25-30 wt. % of montmorillonite, mica and other silicate minerals, 7 wt. % of burning loss and 20-25 wt. % of diatom content.

The slurry may be provided by mixing crude diatomite and water to obtain a desired solids content. The slurry may assist in ease of operability of the subsequent processing of the crude minerals. The water may be added in an amount to achieve a manageable slurry concentration. The water may be added continuously or in stages.

The water may be added to achieve a concentration of about 30% to about 45% by weight, or about 35% to about 45% by weight, or about 35% to about 42% by weight of raw diatomite. The slurry may be mixed in a mixer. The slurry may be mixed at a rate of about 150 rpm to 200 rpm. The slurry of crude minerals may be substantially homogeneously mixed.

Water may be further added to dilute the slurry of diatomite. The slurry may be diluted with water to a concentration of less than about 30 wt. %, or less than about 25 wt. %, or less than about 20 wt. % of raw diatomite. The dilute slurry may have a concentration of more than about 10 wt. %.

A treatment solution may be added to the slurry and thereafter mixed to form a substantially homogeneous dispersion. A paste-like slurry may be formed after the mixing step.

The treatment solution may be a solution having a specific gravity higher than water. The treatment solution may comprise one or more compounds that are capable of forming complexes with charged impurities present in crude diatomite. The treatment solution may comprise one or more compounds that have a net positive charge. Accordingly, the treatment solution may be termed as “a heavy magnetic solution”. The compounds in said treatment solution may associate or interact with oppositely charged particulate impurities to form complexes having higher specific gravity compared to its uncomplexed form, which in turn facilitates removal of these impurities in a settling tank or a gravitational separation step. Advantageously, the treatment solution may therefore assist or improve the separation of fine particulate impurities that are negatively charged (such as clay) from the macro-environment (i.e. the crude slurry) or from the micro-environment (i.e. the surface and pores of the crude diatomite).

Advantageously, the uncharged particles in the crude diatomite may be effectively separated from the charged impurities.

The treatment solution may comprise at least one xanthine derivative, at least one metal silicate or metal phosphate, at least one metal hydroxide and at least one metal carbonate. The metal may be selected from Group 1, 2, or 3 of the Periodic Table of Elements.

The xanthine derivative may be 1,3-dimethyl-7H-purine-2,6-dione (theophylline). In this example, theophylline may be added into the slurry in an amount of about 0.01 wt. % to about 0.1 wt. %, or about 0.03 wt. % to about 0.1 wt. %, or about 0.03 wt. % to about 0.05 wt. %, based on the weight of the crude diatomite. The metal silicate may be a metal metasilicate. The metal silicate may be sodium metasilicate. The sodium metasilicate may be added into the slurry in an amount of about 0.01 wt. % to about 0.5 wt. %, or about 0.1 wt. % to about 0.5 wt. %, or about 0.1 wt. % to about 0.3 wt. %, or about 0.1 wt. % to about 0.2 wt. %, based on the weight of the crude diatomite.

The metal phosphate may be sodium hexametaphosphate. In this example, sodium hexametaphosphate may be added into the slurry in an amount of about 0.01 wt. % to about 0.1 wt. %, or about 0.02 wt. % to about 0.1 wt. %, or about 0.025 wt. % to about 0.1 wt. %, or about 0.02 wt. % to about 0.05 wt. %, or about 0.025 wt. % to about 0.05 wt. %, based on the weight of the crude diatomite in the slurry.

The treatment solution may additionally comprise a base and/or a metal carbonate. The treatment solution may additionally comprise sodium hydroxide and sodium carbonate. The sodium hydroxide may be added into the slurry in an amount of about 0.01 wt. % to about 0.05 wt. %, or about 0.01 wt. % to about 0.03 wt. %, or about 0.01 wt. % to about 0.025 wt. %, based on the weight of the raw diatomite in the slurry. The sodium carbonate may be added into the slurry in an amount of about 0.01 wt. % to about 0.05 wt. %, or about 0.01 wt. % to about 0.04 wt. %, or about 0.015 wt. % to about 0.04 wt. %, or about 0.015 wt. % to about 0.035 wt. %, based on the weight of the raw diatomite in the slurry.

In an embodiment, the treatment solution comprises about 0.03-0.05 wt. % of a xanthine derivative; about 0.1-0.2 wt. % of a metal metasilicate; about 0.025-0.05 wt. % of a metal phosphate; about 0.01-0.025 wt. % of a base; and about 0.015-0.035 wt. % of a metal carbonate.

The slurry may be mixed with the treatment solution in a mixer. The mixer may include a flushing system. The mixer may be a multiple stage mixer, such as a multiple stage conical dispersion stirrer, to ensure thorough mixing and dispersion of the slurry.

In an embodiment, the mixer is a three-stage conical dispersion stirrer. Each stage of the stirrer may be equipped with a mixer, slurry inlet, slurry outlet and flushing outlet. The stirrer speeds of each stage may be set at 1000-1500 rpm, 1200-1800 rpm and 1500-2500 rpm, respectively.

The slurry may be added into the mixer at a flow rate sufficient to permit thorough mixing. For example, the slurry may be fed into the mixer at a flow rate of 250 to 500 kg of slurry per minute. The treatment solution may be added into the mixer before, after or at the same time as the slurry.

The slurry may be subjected to gravitational separation, wherein the diatomite cells are separated from the slurry to thereby form the diatomite treatment agent. The gravitational separation step may include one or more separation steps, which may be performed sequentially or concurrently. In an embodiment, the separation is a three-stage separation process

The slurry may be subjected to a first separation step (coarse separation), wherein bulky particles that are not in suspension and coarse particles having average particle size or particle diameters greater than 200 microns, or greater than 150 microns, or greater than 100 microns are removed from the slurry. The first separation step may separate out the sediment comprising coarse, uncharged particulate impurities, such as quartz and sand, from the suspension and slurry. The particles retained in suspension may be less conducive to settling even though the particle size of the suspended particles may be larger than those that are removed. This may be because the separated material may be of higher relative density as compared to the particles in suspension and hence, the separated material may be more conducive to settling. The first separation step may involve the use of a grit separator. In an example, the grit separator is integrated with stainless steel inclined plates with inclination angle at 70° and spacing at about 30-40 mm, which can effectively remove the particulate matters with a size greater than 150 microns, such as quartz sands and other coarse impurities. It may be appreciated that the separation by size may be tailored according to requirements.

The final slurry concentration after the first separation step may be less than about 30 wt. %, or less than about 25 wt. %, or less than about 20 wt. %, or about 10 wt. % to about 20 wt. % of diatomite.

The slurry may be further subjected to sonication. The sonication may be coupled with or followed by a second separation step.

The second separation step may remove fine particulate impurities, such as fine quartz and sand, having an average particle size or diameter greater than 20 microns. During the second separation step, large diatomite cells or particles are also precipitated with the quartz and sand. The precipitated impurities not in suspension are removed from the slurry. The particles retained in suspension may be less conducive to settling even though the particle size of the suspended particles may be larger than those that are removed. This may be because the separated material may be of higher relative density as compared to the particles in suspension and hence, the separated material may be more conducive to settling. For example, the porosity of diatomite cells retained in suspension may result in a higher Stokes resistance in the slurry and therefore suspends longer than the settled particles regardless of the size. The discharge can be optionally collected for additional purification. The secondary separation step may utilize similar separation methodology as the first separation step. For example, the separation may be gravitational separation, centrifugal separation, sedimentation, settling or a combination thereof.

The sonication may be conducted with an ultrasonic vibration apparatus. The ultrasonic vibration apparatus may comprise a ladder-type pipe, an oscillator placed in the pipe, and an ultrasonic generator which is connected to the oscillator. In this example, the slurry may enter into the ladder-type pipe, where the oscillator provides the micro-oscillation frequency to thereby cause the separation of positively and negatively charged fine particles.

After the second separation step, the slurry concentration may be less than about 25 wt. %, or less than about 20 wt. %, or about 10 wt. % to about 18 wt. % of diatomite. At this stage, the slurry may comprise diatomite and fine particulate impurities, e.g. clay of less than about 20 microns.

The slurry may further be subjected to an electrostatic separation step. The electrostatic separation step may comprise flowing slurry across an applied electric field. The electrostatic separation step may comprise applying an electric field to the slurry. Advantageously, the applied electric field may separate charged fine particles (including ions) from the diatomite surface and the interior surface of the diatomite pore. Advantageously, the applied electric field enhances the purity of diatomite and increases its net surface charge. Advantageously, the applied electric field increases the unbalanced potential on the diatomite particle. All these technical effects may improve the adsorption capabilities of the ultimately purified diatomite.

In one embodiment, a pipe transporting the slurry may be exposed to an electrostatic field. A straight section, e.g. 1.5 m or longer, of the pipe may be exposed to the electrostatic field to maximize exposure.

The electrostatic separation may be conducted at a potential of more than about 50 V, or more than about 60 V, or more than about 70 V, or more than about 80 V, or more than about 90 V or more than about 100 V. The electrostatic separation may be conducted at a potential of about 100 V to about 150 V. The magnitude of the potential difference to be applied is dependent on the volume of slurry being passed through the electric field and the solids content of the slurry.

The electrostatic separation may be conducted at room temperature. Advantageously, thermal energy is not expended during the electrostatic separation step.

A third separation step may be undertaken after electrostatic separation. The third separation step may involve removing very fine clay or particles which remain in suspension and are difficult to remove by gravitational settling. This step may also involve removing diatomite particles that are too small to use. The diatomite particles retained in suspension may have physical properties that are out of the desired range, e.g. a size lower than the desired particle size and/or a density lower than the desired particle density, and therefore are removed. Larger diatomite particles that would not stay in suspension may settle or precipitate to the bottom of the separator. These larger diatomite particles generally have a lower settling velocity than the previously settled particulate impurities. The precipitated diatomite particles having average diameters of between 10 to 200 microns may be collected for use in water treatment methods and systems disclosed herein.

In one embodiment, the third separation step may comprise flowing slurry through a fine separator. The fine separator may be a grit separator or any similar apparatus. In an example, the fine separator is integrated with stainless steel inclined plates with angle at 60° and spacing at about 15-25 mm. In embodiments, the slurry may be transported under plug flow conditions with a flow velocity of 0.1-0.3 mms⁻¹. The slurry concentration in said fine separator may comprise less than about 15 wt. %, or less than about 10 wt. %, or about 5 wt. % to about 10 wt. % of clay. The diatomite particles settled at the bottom of the fine separator may comprise diatomite of substantially high purity and wherein clay-based impurities or minerals are absent. The fine separator may comprise a classification precipitation apparatus. The classification apparatus may comprise a housing having a plurality of plates disposed therein. The plates may be inclined at 60° and spaced about 10-20 mm apart. The apparatus may comprise at least three sections, an upstream (front) section, middle section and a downstream (rear) section. The upstream section may be configured to receive large diatomite particles and the rear section configured to receive very fine diatomite (less than 10 microns). In one embodiment, the middle section may be configured to receive diatomite particles having a substantially narrow size distribution of from 10-200 microns, 10-175 microns, 10-150 microns, 10-125 microns, 10-100 microns, 10-75 microns, 10-50 microns, 10-25 microns, 25-50 microns, 25-75 microns, 25-100 microns, 25-125 microns, 25-150 microns, 25-175 microns, 25-200 microns, 50-75 microns, 50-100 microns, 50-125 microns, 50-150 microns, 50-175 microns or 50-200 microns. In embodiments, the diatomite from the middle section is collected as wet diatomite for further processing into the diatomite treatment agent of the present invention.

A schematic diagram showing an exemplary diatomite pre-treatment process in accordance with the present invention is illustrated in FIG. 1. The first separation step 102 involves the addition of a heavy magnetic solution to crude diatomite to form a slurry. Uncharged and coarse particulate impurities that are not in suspension are removed in stream 102b. Stream 102a is subjected to the second separation step 104 involving the separation and removal of fine particulate impurities having an average particle size or diameter greater than 20 microns and possibly large diatomite particles from the slurry suspension (stream 104b). The slurry suspension in stream 104a is subjected to the third separation step 106, whereby a suspension of fine particles not conducive to settlement is removed in stream 106b. The diatomite particles are separated based on their settling velocities and are discharged as stream 106a to be further processed as disclosed herein.

Wet diatomite may be collected after classification and subjected to drying. Vacuum dehydration may be used to expedite the drying. The drying medium may be hot air at a temperature of about 150-250° C.

The obtained dried purified diatomite product may be used as a diatomite treatment agent in a waste water treatment process, such as the one disclosed herein. The obtained dried product may be in the form of powder.

The purified diatomite may have a purity of at least about 90%. That is, the obtained dried product or the diatomite treatment agent may comprise at least about 90% by weight of diatomite particles, or at least about 91% by weight of diatomite particles, or at least about 92% by weight of diatomite particles, or at least about 93% by weight of diatomite particles, or at least about 94% by weight of diatomite particles, or at least about 95% by weight of diatomite particles, or at least about 96% by weight of diatomite particles, or at least about 97% by weight of diatomite particles, or at least about 98% by weight of diatomite particles, or at least about 99% by weight of diatomite particles, or at least about 99.9% by weight of diatomite particles. The diatomite treatment agent may comprise about 90% to about 92% by weight of diatomite particles, or about 90% to about 95% by weight of diatomite particles, or about 90% to about 98%, or about 98% to about 99.9% by weight of diatomite particles.

Advantageously, the disclosed method of preparing purified diatomite enables diatomite to be substantially or completely separated from other detrital minerals, clay, quartz, silica sand, metal salts, oxides and hydroxides and other impurities from the diatomite and further provides classification of the diatomite into different grades.

In one example, the chemical composition of the purified diatomite comprises 82 wt. % of SiO₂, <8 wt. % of Al₂O₃, <2.5 wt. % of Fe₂O₃, 5 wt. % of burning loss, >92 wt. % of diatom content and a bulk density of <0.4 g/cm³. As a comparison, the chemical composition of conventionally refined diatomite comprises 76 wt. % of SiO₂, <10 wt. % of Al₂O₃, <3.5 wt. % of Fe₂O₃, 5 wt. % of burning loss, >88 wt. % of diatom content and a bulk density of <0.4 g/cm³.

The disclosed method of preparing high grade diatomite may be more economical than prior art methods. The disclosed method of preparing high grade diatomite may be more environmentally friendly than prior art methods as harsh chemical treatment of diatomite is not required. The disclosed method of preparing high grade diatomite may achieve high yields of product.

The diatomite treatment agent may have a bulk density of about 0.3 to about 0.4 g/cm³.

The diatomite treatment agent may have a pore size of about 200 to about 600 nm, or about 200-500 nm, or about 200-400 nm, or about 300-600 nm, or about 300-500 nm, or about 250-550 nm, or about 250-500 nm.

Due to the efficiency of the disclosed method of preparing the diatomite treatment agent, the pores of the diatomite are substantially not clogged with mineral impurities. Accordingly, the diatomite treatment agent may have a substantially increased pore volume of about 0.6 to about 0.8 cm³/g.

The diatomite treatment agent may have a surface area of about 50 to about 60 m²/g. The removal of impurities and charged particles from the external surface and the internal pore surface of the diatomite cells advantageously increase the effective surface area of the diatomite treatment agent. The huge surface area of the diatomite treatment agent may advantageously result in a lower dosage of diatomite treatment agent required in the disclosed process of treating waste water. For example, a diatomite treatment agent concentration of about 1 wt. % in wastewater may advantageously provide an effective surface area of 600,000 m²/m³ of wastewater.

The diatomite treatment agent may be used in the disclosed process of treating waste water. Active functional/charged groups may be present on the surfaces of the diatomite to advantageously adsorb undesirable matters in waste water, such as ultrafine particulate matter, microbes, coloring agents, toxic and hazardous substances and foul-smelling compounds during waste water treatment. The adsorbed composites may be easily separated from the water body by settling. Due to the increased adsorbent properties of the purified diatomite prepared by the disclosed method, the diatomite treatment agent may be used as the sole treatment agent in waste water treatment to provide effective waste water treatment. Moreover, the disclosed method also does not require the use of coagulants or flocculants.

This is advantageous because secondary pollution or contamination is avoided.

Exemplary, non-limiting embodiments of the process for treating waste water will now be disclosed. In one embodiment, the waste water treatment process comprises the steps of: a) contacting microbes with a waste water stream to form a mixed liquor stream comprising activated sludge; b) dosing said mixed liquor stream with at least one diatomite treatment agent; c) separating water from said mixed liquor stream to thereby provide a treated waste water effluent; and wherein said diatomite treatment agent consists purified diatomite as prepared herein. In embodiments, the diatomite treatment agent is one that has been obtained from the pre-treatment processes as disclosed herein.

In one embodiment, the purified diatomite comprises diatomite that has been purified from crude diatomite, wherein the purification process comprises treating crude diatomite with a solution consisting of: theophylline (0.03-0.05 wt. %), sodium metasilicate (0.1-0.2 wt. %) or sodium hexametaphosphate (0.025-0.05 wt. %), sodium hydroxide (0.01-0.025 wt. %), and sodium carbonate (0.015-0.035 wt. %). All weight percentages are expressed based on the total weight of the crude diatomite being purified.

The waste water to be treated may be waste water resulting from agricultural wastewater, municipal wastewater, sewage or industrial wastewater, such as from the paper, sugar or rubber industries. The raw waste water may come from concentrated sources such as landfill leachate.

The raw water may be pre-treated to remove suspended solid particles that may be heavier in specific gravity than the raw water. The solid particles may be removed by known methods, such as settling, sedimentation or screening. The settled solids may be easily removed. The water remaining after solids removal may be further treated. Further treatment may include sludge settling and oil removal.

The waste water stream may be subjected to biological treatment to degrade or remove dissolved and suspended compounds. These compounds may include organic matter and nutrients that facilitate the growth of bacteria and algae.

The wastewater may be contacted with a variety of microbes to break down or metabolize carbonaceous biological matter or nitrogenous matter. Microbes include indigenous bacteria from the wastewater itself, aerobic bacteria, anoxic bacteria, anaerobic bacteria, fungi and unicellular organisms. The wastewater may be contacted with varying species of bacteria in varying environments to take advantage of the appropriate environment and available nutrients. The heterogeneous cultures of bacteria perform a variety of biological processes which either assimilate nutrients into a biomass or convert nutrients into less environmentally toxic forms.

The degradation results in a decrease in the undesirable organic content of the wastewater and produces relatively harmless by-products. The microbes retained in the water become part of the activated sludge. Activated sludge may also comprise remnants from the biodegradation.

In some embodiments, the microbes may be anoxic bacteria. The anoxic treatment of the waste water stream denitrifies the water by converting nitrates from nitrogenous matter to nitrogen gas or nitrous oxides. The anoxic treatment may be conducted at a temperature no lower than about 8° C. The anoxic treatment may be conducted at about 15° C. to about 35° C., or at room temperature, e.g. about 20° C. to about 35° C. The anoxic treatment may be conducted at a pH ranging from about 6 to about 9. The anoxic treatment may be conducted for a duration to sufficiently degrade nitrogenous matter in the waste water.

In some embodiments, the microbes may be aerobic bacteria. Aerobic bacteria metabolize organic material and nutrients to produce carbon dioxide, among others. For example, the aerobic treatment of the waste water stream may convert foul-smelling ammonia to neutral-smelling nitrates.

The aerobic treatment may be conducted at a temperature no lower than about 5° C. The aerobic treatment may be conducted at about 15° C. to about 35° C., or at room temperature, e.g. about 20° C. to about 35° C. The aerobic treatment may be conducted at a pH ranging from about 6 to about 9. The aerobic treatment may be conducted for a duration sufficient to degrade nitrogenous matter in the waste water.

The anoxic treatment may be conducted before or after the aerobic treatment. In an embodiment, the anoxic treatment is conducted before the aerobic treatment. In an embodiment, the effluent from the anoxic treatment flows to the aerobic treatment. In an embodiment, the effluent from the aerobic treatment may be recycled back to the anoxic treatment.

The effluent from the biological treatment may comprise a mixed liquor stream comprising activated sludge. The diatomite treatment agent may be mixed with the mixed liquor stream. The diatomite treatment agent may be added to the mixed liquor stream upstream of the separating step c). The diatomite treatment agent may also be mixed with the waste water prior to or during the biological treatment steps.

Advantageously, the diatomite treatment agent may be capable of adsorbing the microbes after their use in the biological treatment zone. As mentioned above, the diatomite treatment agent is pre-treated according to the pre-treatment process disclosed herein and therefore advantageously possesses large surface area for adsorption of microbes and particulate matter on its surfaces. Further advantageously, the active functional/charged groups present on the surfaces of the diatomite treatment agent may aid in the adsorption of particulate matter and microbes. Thus, the suspended solids, bacteria and other microorganisms in the activated sludge that are adsorbed on the exterior surface and porous interior surfaces of the diatomite treatment agent may be separated from the mixed liquor stream. The microbes attached on the diatomite treatment agent may be separated from the mixed liquor stream in this manner and recycled back to the biological treatment zone, thereby providing savings in raw material cost. Further advantageously, undesirable matters in the mixed liquor stream, such as ultrafine particulate matter, microbes, coloring agents, toxic and hazardous substances and foul-smelling compounds may be separated from the mixed liquor stream in this manner.

Even further advantageously, the diatomite treatment agent may adsorb phosphate compounds in the waste water. The adsorption and removal of phosphate from the waste water by the diatomite treatment agent may obviate the need for additional phosphorous removal processes, e.g. by anaerobic treatment or by chemical treatment.

The diatomite treatment agent may be dosed at from about 5 milligrams per litre of waste water (“mg/L”) to about 50 mg/L, or about 10 mg/L to about 50 mg/L, or about 15 mg/L to about 50 mg/L, or about 5 mg/L to about 40 mg/L, or about 5 mg/L to about 30 mg/L, or about 10 mg/L or about 40 mg/L or about 10 mg/L or about 30 mg/L. Advantageously, the dosage of diatomite treatment agent is relatively low, resulting in relatively low operating cost.

The mixed liquor stream exiting the biological treatment zone may be conveyed to a clarifier, e.g., by gravitational flow. The clarifier may be located or physically positioned at a lower vertical level than the biological treatment zone. In an embodiment, a pump is not required to convey the effluent to the clarifier. Advantageously, the energy requirements to move the wastewater may be kept low, translating into cost savings.

The clarifier may be configured or arranged to optimize mixing and contact of the diatomite treatment agent with the mixed liquor stream from the biological treatment zone, with the purpose of adsorbing the microbes/undesirable matters from the mixed liquor on the surfaces of the diatomite treatment agent. The clarifier may also be configured or arranged to optimize the separation of the adsorbed microbes/matters, also referred to herein as “suspended solids”, from the liquor, to thereby produce treated waste water.

The clarifier may be constructed in any shape. In embodiments, when viewed from the top, the clarifier may be quadrilateral in shape, e.g. square or rectangular. Advantageously, such shapes provide flexibility of arrangement and construction of the clarifier, in turn saving land and construction cost.

The clarifier may comprise one or two or more zones to aid in the separation of water from the mixed liquor stream comprising activated sludge.

The clarifier may comprise a mixing zone. The mixing zone may receive the mixed liquor stream from the biological treatment zone. The mixing zone may be configured to receive the mixed liquor stream at any vertical level of the mixing zone. In an embodiment, the mixing zone is configured to receive the mixed liquor stream proximate the top of the mixing zone. The mixing zone may be configured to aid the mixing and optimize contact between the activated sludge in the mixed liquor stream and the diatomite treatment agent to obtain a stream comprising biomass/microbes supported on the diatomite treatment agent. The mixing zone may be configured to comprise agitation means, such as stirrers or baffles. In one embodiment, mechanical mixers, such as stirrers, are not required in the mixing zone or the clarifier because the gravitational flow of the incoming mixed liquor stream advantageously allows self-mixing. Hence, energy consumption of the clarifier may be advantageously kept at a minimum, resulting in significant energy savings. The mixing zone may also advantageously provide homogenous mixing of the diatomite treatment agent and the mixed liquor stream.

The clarifier may comprise a coagulation zone which may be fluidly connected to the mixing zone. The coagulation zone is configured to provide continual mixing, blending or coalescence between the mixed liquor stream and the diatomite treatment agent. Advantageously, the adsorption of matter onto the diatomite treatment agent may be aided within the coagulation zone to enhance the separation of microbes and particulate matter from the mixed liquor stream. The coagulation zone may be configured to enhance the turbulence of the fluid flow for the purpose of increasing contact between the diatomite treatment agent and the microbes and particulate matter in the mixed liquor stream. For example, the coagulation zone may be arranged such that the fluid flow is in a zig-zag manner or other hydraulically advantageous flow arrangement. The coagulation zone may comprise baffles or other physical structures to increase flow turbulence. The coagulation zone may be configured such that the fluid overflows out of the coagulation zone into a sedimentation zone of the clarifier. For example, the coagulation zone may comprise an adjustable compartment separator to control or adjust the flow velocity of the fluid entering the sedimentation zone.

The clarifier may comprise at least one of the mixing zone and the coagulation zone or both the mixing zone and the coagulation zone.

The stream exiting the mixing zone and the coagulation zone may comprise solids, which are matter or microbes adsorbed on the diatomite treatment agent or other unadsorbed solids, suspended in liquor and water.

The clarifier may comprise a sedimentation zone. The sedimentation zone may receive the mixed liquor stream from the coagulation zone and/or the mixing zone. The sedimentation zone may be configured or arranged to optimize separation of the suspended solids from the liquid liquor. The separation or settling of the suspended solids layer may be achieved when the various forces acting on the mixed liquor stream are allowed to attain equilibrium. In an example, the mixed liquor stream may overflow from the coagulation zone and/or the mixing zone, thereby subjecting the suspended solids and the liquor to a gravitational force. Further, the suspended solids may be denser than the liquor and therefore may sink as the mixed liquor stream enters the sedimentation zone of the clarifier. Even further, the continuous entry of the liquor stream into the sedimentation zone may cause the suspended solids layer and the liquor already in the sedimentation zone to displace upwards, thereby creating an upward drag force. The fluid movement created by the sinking of the suspended solids, the gravitational force and the upward drag force of the liquor creates friction. In embodiments, the various forces acting on the suspended solids and the liquor may be allowed to reach an equilibrium by adjusting, controlling or optimizing the flow rate of the mixed liquor stream into the clarifier. In an embodiment, the flow velocity of the incoming liquor stream into the sedimentation zone may vary from about 0.4 mm/s to 1.0 mm/s. When the various forces reach equilibrium, e.g. when the suspended solids reach a constant settling velocity, a sludge blanket comprising the suspended solids layer may form at an equilibrium vertical level of the clarifier, for example at an upper section of the clarifier.

The formation of the sludge blanket may be controlled by adjusting the flow rate of the incoming liquor stream, e.g. by use of adjustable valve(s) or an adjustable compartment separator between the coagulation/mixing zone and the sedimentation zone. As mentioned above, the sludge blanket or suspended solids layer may comprise microbes adsorbed on the diatomite treatment agent. When the liquid liquor passes through the sludge blanket, the adsorbed microbes in the sludge blanket may advantageously degrade any organic material remaining in the liquor. Further advantageously, the diatomite treatment agent in the sludge blanket may adsorb any undesirable particulate matters remaining in the liquor. Accordingly, the sludge blanket advantageously provides a final step to clarify/polish the liquid liquor, resulting in treated waste water.

While a thicker or larger sludge blanket would comprise a larger amount of diatomite treatment agent or supported microbes therein to further clarify/polish the waste water to be treated, a larger resistance is created for the liquid that passes through the sludge blanket, which may result in excessively long sludge retention time. An excessively long sludge retention time may create anaerobic conditions which undesirably releases methane and causes sludge floating. Accordingly, in embodiments, the sludge blanket formed may be of a thickness of no more than a third of the height of the sedimentation zone. Any excessive sludge may be recycled to the biological treatment zone.

Therefore, the sedimentation zone may be operated to suspend an appropriate amount of a suspended solids layer or sludge blanket therein.

The fluids passing through the sludge blanket in the sedimentation zone, e.g. the treated waste water, may exit the clarifier via one or more outlets. In some embodiments, the outlet for treated waste water is located proximate the top of the sedimentation zone. Accordingly, liquor displaced upwards that has passed through the sludge blanket and therefore has become treated waste water may exit the clarifier via the outlet proximate the top of the sedimentation zone. In an embodiment, the treated waste water may overflow out of the sedimentation zone into a catchment weir which is fluidly connected to the treated waste water outlet. The catchment weir uniformly distributes liquid flow to minimize resuspension of sludge particles.

In some embodiments, the section of the sedimentation zone above the sludge blanket may be configured to restrict or resist fluids from overflowing out of the sedimentation zone. Advantageously, fluid resistance enhances the sludge-water separation process, thereby allowing treated waste water to exit the clarifier but preventing sludge from carrying over and out of the clarifier. Fluid resistance may be provided by the use of gravity and/or friction. For example, fluid resistance may be provided in the form of a plate guiding fluid flow upwards, but inclined at an angle so as to cause resistance to the movement of sludge particles. In an embodiment, a plurality of plates may be provided.

Advantageously, due to the angle of flow, the sludge particles travel a shorter distance, expending shorter time, as compared to the vertical distance traveled in conventional clarifiers. Accordingly, the loading of the clarifier may be advantageously enhanced. Further advantageously, the disclosed sedimentation zone permits a larger amount of sludge to sediment at the bottom of the sedimentation zone. Still advantageously, the provision of the inclined plates allows for a smaller dip angle of the sedimentation zone, since conventional clarifiers need to be either conical shaped or have bottom sections that are angled to aid in sedimentation. A smaller dip angle therefore advantageously reduces the total clarifier height.

The sedimentation zone may be capable of recycling sludge or suspended solids to the mixing zone and/or the coagulation zone. Advantageously, the suspended solids comprises diatomite treatment agent which are recycled to the mixing zone and/or the coagulation zone, thereby enhancing the chance of contacting microbes and particulate matter onto the diatomite treatment agent. Accordingly, the sedimentation zone may comprise an outlet to recycle the sludge to the mixing zone and/or the coagulation zone and/or the biological treatment zone. This outlet may be located at the base of the sedimentation zone. The floor of the sedimentation zone may be angled so as to direct the sludge flow towards the outlet.

The sedimentation zone may further comprise a scraper to scrape any solids and sludge that adhere to the sides of the sedimentation zone. Advantageously, any solids stuck to the walls of the sedimentation zone may be moved into the liquor to join the suspended solids layer.

Therefore, the separating step c) may comprise conveying the mixed liquor stream to the clarifier at an incoming flow velocity adjusted to dispose a layer of suspended sludge at a vertical level of the clarifier or the sedimentation zone of the clarifier; and discharging the liquor that has passed through the suspended sludge solids layer as treated waste water effluent.

The suspended solids layer may comprise the diatomite treatment agent and particulate matter/biomass/microbes adsorbed onto the diatomite. The dynamic and continuous upflow and downflow of solids/liquid occurring in the suspended solids layer may further aid in mixing the diatomite treatment agent with particulate matter in the water to optimize contact and adsorption. The bacteria in the activated sludge may also provide further biological treatment and removal of organic nutrients. The suspended solids layer may be termed “a sludge filtration blanket” or a “sludge blanket”.

The sludge filtration blanket may be disposed proximate to an upper section of the sedimentation zone of the clarifier. Each millimeter of the sludge blanket may contain up to 300,000 layers of diatomite cells and effectively provides nano-filtration to the upflowing waste water. The diatomite cells may also act as a support for microbes on its surface or within its pores. That is, the diatomite treatment agent may act as a carrier for biomass material.

Advantageously, the sludge filtration blanket aids in improving the quality of the treated waste water effluent. Advantageously, there may be no sludge bulking in the effluent. Advantageously, the duration of biological treatment may be reduced due to efficient removal of particulate matter and organic matter from the wastewater. For example, the retention time of sewage wastewater in the anoxic zone may advantageously be as short as 1.5 hours, while the retention time of the sewage wastewater in the aerobic zone may be as short as 3 hours.

Waste water that has passed through the sludge blanket may be discharged as treated waste water effluent.

At least a fraction of the contents of the clarifier may be continuously or periodically discharged.

At least some of the solid contents of the clarifier may be continuously or periodically recycled to the biological treatment, such as the anoxic treatment.

At least a fraction of the suspended solids may be periodically discharged and optionally recycled to the waste water stream in step a).

Advantageously, where the contents of the clarifier are recycled to the biological treatment, the solids content during biological treatment may be controlled. For example, when the MLSS (mixed liquor suspended solids) build up to 10,000 mg/L in the biological treatment tank, the clarifier may discharge activated sludge (termed as “Waste Activated Sludge” or “WAS”) until the MLSS in the biological treatment tank is reduced to 7,000 mg/L.

The discharged sludge may be treated prior to recycle or be disposed of. For example, the WAS may be dewatered using a filter press or drawer-type sludge dehydration device without prior thickening or dosing of polymers. Advantageously, the superior adsorption properties of the diatomite treatment agent and prolonged sludge retention time resulting from the use of diatomite as a biomass carrier result in a reduced amount of sludge produced.

Advantageously, the waste water treatment process may be a continuous process, thereby reducing shutdown time. A large capacity of raw water may be processed. The capacity may be adjusted to suit demand, regulatory requirements or the source of raw water. For example, 40,000 m³/d of raw water may be processed, wherein 30-50% is derived from sewage and 50-70% is derived from industrial waste water. The disclosed waste water treatment process may achieve high efficiency and the waste water effluent from the process can be recycled.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram showing an exemplary diatomite purification process in accordance with the present invention.

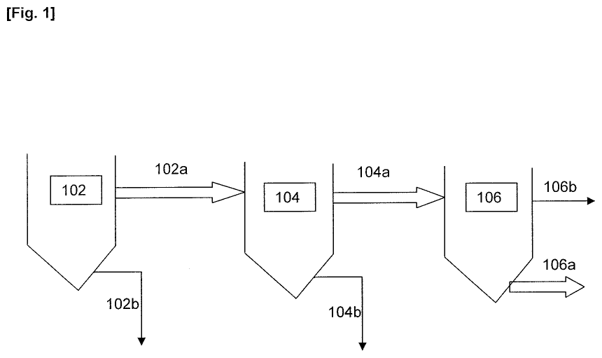

FIG. 2 is a schematic diagram showing an exemplary waste water treatment system in accordance with the present invention.

FIG. 3 is a schematic diagram showing a clarifier in accordance with the present invention.

### DETAILED DESCRIPTION OF DRAWINGS

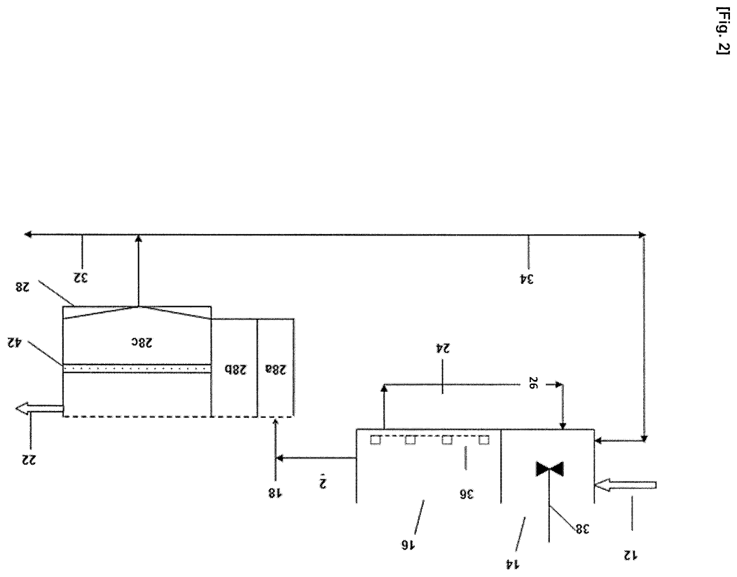

Referring to FIG. 2, there is shown an embodiment of a section of a waste water treatment system according to the present invention. The waste water treatment system comprises a biological treatment zone (14, 16), the biological treatment zone having at least one anoxic reactor 14 and at least one aerobic reactor 16. The reactors are arranged in sequence and fluidly communicated (not shown). Waste water 12, which may have undergone primary waste water treatment, e.g., settling or sedimentation in another section of the waste water treatment system, is charged to the anoxic reactor 14 as waste water influent.

At this stage, influent waste water 12 may typically have a COD of around 60-700 mg/L, a BOD of about 25 to about 500 mg/L, suspended solids of around 30-250 mg/L, ammonia nitrogen about 5 to 50 mg/L, total phosphorus content of about 0 to 15 mg/L and a pH of about 6 to 9.0.

At reactor 14, denitrification takes place whereby nitrite is metabolized by microorganisms to nitrogen gas, which can be freely released into the environment. The anoxic reactor may comprise suitable mixing means 38 to increase microbe activity and to reduce total residence time. At the aerobic reactor 16, the waste water may undergo nitrification process whereby microbes provided within the reactor metabolize ammonia to nitrite. Suitable aeration means 36 may be provided to provide oxygen for microbial respiration. The aeration means may also act as a mixing means. At least a fraction of the waste water discharged from reactor 16 is recycled into anoxic reactor 14 via recycle stream 24.

The mixed liquor 26 discharged from the biological treatment zone may contain lower BOD than influent waste water 12. The discharged mixed liquor 26 is mixed with diatomite treatment agent 18. While not shown, the diatomite treatment agent 18 may also be added independently, separately, or concurrently to reactors 14 and 16. Mixed liquor 26, after being mixed with the diatomite treatment agent 18 is then transported to a clarifier (28). Clarifier 28 has three sections: mixing zone 28a, coagulation zone 28b and sedimentation zone 28c. Preferably, the mixed liquor 26 is fed to a top section of the mixing zone 28a of the clarifier 28 under the action of gravity.

The clarifier 28 and particularly the sedimentation zone 28c can be operated to form a sludge blanket 42 by adjusting the flow velocity of the incoming mixed liquor stream 26 so as to achieve an equilibrium point at a pre-determined vertical level of the clarifier 28. Preferably, the sludge blanket 42 is formed proximate to an upper section of the sedimentation zone 28c of clarifier 28. Due to the presence of the diatomite treatment agent, the sludge blanket 42 acts as an ultra-efficient filtration means to the waste water passing through the sludge blanket. Waste water that has passed through the sludge blanket 42 is finally discharged as treated waste water effluent 22, leaving behind suspended solids or sludge in the clarifier 28.

The sludge contained in the clarifier 28 may be periodically discharged to maintain a pre-determined level of suspended solids present within the clarifier 28. The discharged sludge may be partially recycled to the anoxic reactor 14 as return activated sludge 34 or discharged as waste activated sludge 32. For instance, the disclosed system may comprise at least one conduit fluidly communicating the clarifier with the biological treatment zone, the conduit being operable to recycle at least a fraction of the suspended solids as return sludge 34.

The waste activated sludge 32 may undergo dewatering or dehydration (not shown) prior to disposal, e.g. to a landfill or incinerator, or to be further used as construction material or fertilizer. In an advantageous aspect of the present system, there is no need to add a flocculant or coagulant to the sludge during dewatering due to the use of the diatomite treatment agent disclosed herein that adsorbed particulate matter. In another advantageous aspect of the present system, the waste activated sludge 32 may advantageously be directly conveyed to the dewatering step without the need for thickening in a sludge thickener or discharging to a sludge holding tank, as required by conventional systems.

Accordingly, in one embodiment of the present disclosure, the waste water treatment system comprises at least one biological treatment zone configured to receive and contact waste water with microbes to thereby form a mixed liquor stream comprising activated sludge; a clarifier in fluid communication with said biological treatment zone and configured to receive said mixed liquor stream discharged from said biological treatment zone; an inlet means disposed upstream of said clarifier operable to introduce a diatomite treatment agent to said mixed liquor stream; wherein said diatomite treatment agent comprises unbalanced surface charges and is one disclosed herein; and an outlet means extending from said clarifier, being configured to discharge water that has been separated from the mixed liquor stream as treated waste water effluent.

The biological treatment zone may comprise at least one or a plurality of reactors or bioreactors operable to contact microorganisms with waste water. The plurality of reactors may be arranged in sequence to treat the waste water in successive stages. The bioreactors may be individually subject to anoxic, aerobic or anaerobic conditions.

The diatomite treatment agent may be as disclosed above or is obtained from a pre-treatment of crude diatomite as disclosed herein.

In one embodiment, the disclosed system comprises a biological treatment zone comprising at least one anoxic reactor for denitrification (converting nitrate NO₃⁻ and/or nitrite NO₂⁻ to nitrogen gas). The anoxic reactor may be configured to receive waste water that is anoxic. The anoxic reactor may also receive waste water that has undergone nitrification in at least one aerobic reactor where ammonia is converted to nitrate and/or nitrite, e.g., via a recycle stream.

The inlet means disposed upstream of the clarifier may be operated to introduce the diatomite treatment agent continuously or batch-wise to the mixed liquor stream. The inlet means may be configured to dose the diatomite treatment agent at about 10 milligrams to about 30 milligrams per litre of waste water. One or more flow meters may be placed at appropriate locations to determine a flow rate of waste water in order to provide a corresponding diatomite dosing rate. The disclosed system may further comprise a dehydration zone arranged to receive sludge discharged from the clarifier. The dehydration zone may be further fluidly communicated with the biological treatment zone to recycle the bacteria and microorganisms in the sludge to treat the waste water in the biological treatment zone.

Advantageously, because of the improved diatomite agent, the dehydration operation may be performed without addition of flocculant or coagulant. The dehydration zone may comprise suitable sludge dewatering apparatus, e.g., filter press. The dehydration or dewater processes may be conducted batch-wise or in a continuous mode of operation.

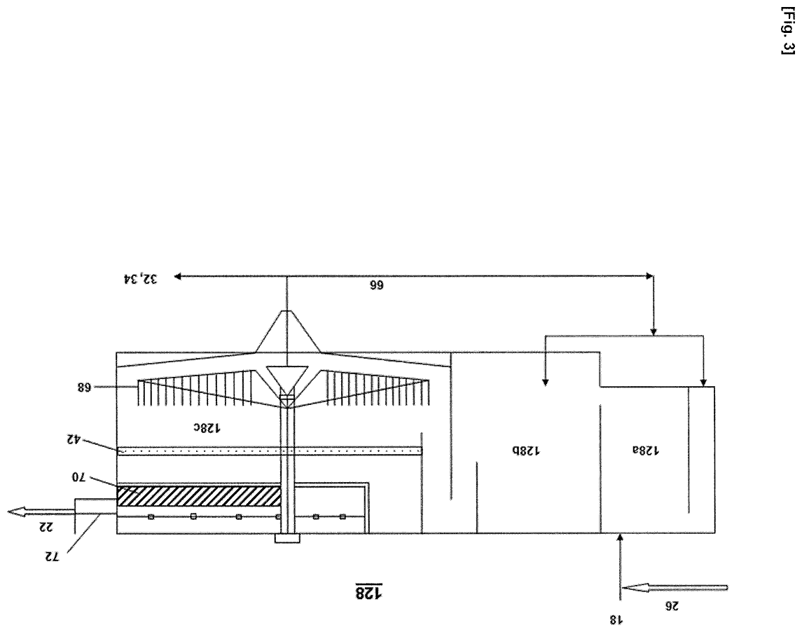

Referring to FIG. 3, there is shown an embodiment of a clarifier 128 according to the present invention. Clarifier 128 is a specially designed mechanical accelerating settling tank.

Clarifier 128 has three sections: mixing zone 128a, coagulation zone 128b and sedimentation zone 128c. Diatomite treatment agent 18 and Mixed liquor stream 26 discharged from the biological treatment zone (not shown) is added into a stream of diatomite treatment agent 18 and the mixture is added into mixing zone 128a. Alternatively and as mentioned herein, the diatomite treatment agent 18 may also be added independently, separately, or concurrently to the biological treatment zone or to the mixed liquor 26 or directly to mixing zone 128a. Diatomite treatment agent 18 and mixed liquor 26 are homogenously mixed in the mixing zone 128a by the gravitational force of the mixed liquor 26 and optionally by mechanical agitation means such as stirrers or baffles.

The mixture of liquor 26 and diatomite treatment agent 18 passes into coagulation zone 128b where coagulation of suspended solids takes place, the suspended solids comprising diatomite treatment agent 18 having adsorbed particulate matter and microbes thereon. Thereafter, the mixture overflows into sedimentation zone 128c. The coagulation zone 128b may comprise one or more partitions to guide the mixture to flow into sedimentation zone 128c.

Sedimentation zone 128c allows settling of the suspended solids and thus the suspended solids separate from the waste water or liquor, forming a sludge blanket 42 in the sedimentation zone 128c. Due to the presence of the diatomite treatment agent 18, the sludge blanket 42 acts as an ultra-efficient filtration means to the waste water passing through the sludge blanket 42. The formation of the sludge blanket 42 is controlled by adjusting the flow velocity of the incoming mixed liquor stream 26. Sedimentation zone 128c comprises an inclined plate 70 at the top of the sedimentation zone 128c. Inclined plate 70 is selectively permeable, comprising pores that allow water or the treated waste water effluent to pass through but prevent suspended solids from passing through. Inclined plate 70 is inclined so as to direct the treated waste water effluent into a catchment weir 72 which finally discharges the treated waste water effluent as stream 22. Sedimentation zone 128c also comprises a rotatable rotary scraper 68 used to scrape the sludge that adheres to the walls of the sedimentation zone 128c. The sludge or suspended solids in the sedimentation zone 128c may be periodically discharged to maintain a pre-determined level of suspended solids present within the clarifier 128. The discharged sludge may be partially recycled to the biological treatment zone (not shown) as return activated sludge 34 or as waste activated sludge 32. The discharge sludge may also be partially recycled to the mixing zone 128a and/or the coagulation zone 128b of the clarifier 128 as stream 66 to increase the chance of collision or contact between the colloidal particles of diatomite treatment agent, microbes and particulate matter.

### EXAMPLES

The following examples should not be construed as in any way limiting the scope of the invention.

### Example 1

The diatomite treatment agent prepared by the method as disclosed herein was shown to have better adsorption capability and was more effective in removing pollutants.

In this example, two types of influent waste water were used in separate experiments, the first was influent from sewage and the second was influent from mineral processing. The sewage influent was used to test the performance of the diatomite treatment agent in removing biological matters (COD/BOD) and nutrient matters (nitrogen/phosphorus). The industrial mineral processing influent was used to test the performance of the diatomite treatment agent in removing heavy metals. The quality of the influent waste water was as follows:

TABLE 1

| No | | Amount | |
|---|---|---|---|
| | Pollutant (from sewage | | |
| | influent) | | |
| 1 | COD | 445 | mg/L |
| 2 | BOD | 280 | mg/L |
| 3 | Ammonia Nitrogen | 34 | mg/L |
| 4 | Total Nitrogen | 48 | mg/L |
| 5 | Phosphorus | 6.17 | mg/L |
| | Pollutant (from mineral | | |
| | processing influent) | | |
| 6 | Cu (II) | 1.773 | mg/L |
| 7 | Zn (II) | 146.1 | mg/L |
| 8 | Pb (II) | 8.450 | mg/L |
| 9 | Cd (II) | 0.556 | mg/L |
| 10 | Cr (VI) | 0.014 | mg/L |

The dosage of diatomite treatment agent used was 10-30 mg/L.

The results of the treatment are shown in Table 2 below.

TABLE 2

| | | Adsorption/Removal Rate | |
|---|---|---|---|
| | | Diatomite Treatment | Conventional |
| | | Agent of present | refined |
| No | Pollutant | invention | Diatomite |
| 1 | COD | 80.00% | 70-75% |
| 2 | BOD | 80-92.8% | 70-85% |
| 3 | Ammonia | up to 70.0% | 30% |
| | Nitrogen | | |
| 4 | Total Nitrogen | up to 85.0% | up to 78.7% |
| 5 | Phosphorus | up to 97.7% | up to 91.2% |
| 6 | Cu (II) | 94.70% | 90% |
| 7 | Zn (II) | 99.90% | 90% |
| 8 | Pb (II) | 98.90% | 90% |
| 9 | Cd (II) | 97.30% | 90% |
| 10 | Cr (VI) | 95.00% | 90% |

### Example 2

Waste water treated by the system as disclosed herein was shown to meet regulatory Discharge Permit Limits.

In this example, 30-50% of the influent waste water was derived from sewage and 50-70% was industrial-derived from factories, like food processing, soya sauce production, beverage making, etc. The dosage of diatomite treatment agent used was 10-30 mg/L.

The results of the treatment are shown in Table 3 below.

TABLE 3

| | Actual | Discharge Permit | Actual Average |
|---|---|---|---|
| Parameters | Influent | Limit | Effluent |
| COD (mg/L) | 68.3-660 | 60 | 20.2 |
| BOD (mg/L) | 29-483 | 20 | 3.31 |
| Suspended Solids | 29-215 | 20 | 6.63 |
| (mg/L) | | | |
| Ammonia Nitrogen | 5.56-42.72 | 8 | 0.22 |
| (mg/L) | | | |
| Total Nitrogen | 12.08-50.10 | 20 | 4.59 |
| (mg/L) | | | |
| Total Phosphorus | 0.86-10.60 | 1 | 0.07 |
| (mg/L) | | | |
| pH | 6.17-8.43 | 6.9-9.0 | 7.54 |

### INDUSTRIAL APPLICABILITY

The disclosed waste water method and system provides numerous advantages over conventional treatment process. Thus, industrial applicability is taken to be self-evident.

Various modifications and adaptations of the invention will be apparent to the person skilled in the art after reading the foregoing disclosure without departing from the spirit and scope of the invention and it is intended that all such modifications and adaptations come within the scope of the appended claims.

What is claimed:

1. A waste water treatment process comprising the steps of:
a) contacting microbes with a waste water stream to form a mixed liquor stream comprising activated sludge;
b) dosing said mixed liquor stream with at least one diatomite treatment agent;
c) separating water from said mixed liquor stream to thereby provide a treated waste water effluent; and
wherein optionally, said contacting step and said dosing step are performed concurrently or sequentially,
wherein said diatomite treatment agent comprises 98 to 99.9% by weight of diatomite particles, said diatomite particles comprising unbalanced surface charges, and
wherein said diatomite treatment agent is obtained from a pre-treatment process comprising: contacting crude diatomite with a treatment solution to form a slurry, the treatment solution comprising, based on the weight of the crude diatomite, about 0.03-0.05 wt. % of at least one xanthine derivative, about 0.1-0.2 wt. % of at least one metal metasilicate, about 0.025-0.05 wt. % of at least one metal phosphate, about 0.01-0.025 wt. % of at least one base and about 0.015-0.035 wt. % of at least one metal carbonate.

2. The process of claim 1, wherein said diatomite treatment agent consists essentially of diatomite cells, said diatomite cells being substantially free of counter ions electrostatically coupled to its surface, and wherein optionally each diatomite cell comprises a plurality of pores having an interior pore surface, the interior pore surface being substantially free of counter ions or charged impurities being electrostatically coupled thereto.

3. (canceled)

4. The process of claim 1, wherein said diatomite treatment agent is dosed at about 10 milligrams to about 30 milligrams per litre of waste water.

5. The process of claim 1, wherein said diatomite treatment agent is substantially free of a flocculant or a coagulant.

6. The process of claim 1, wherein said separating step comprises conveying said mixed liquor stream to a clarifier; controlling the velocity of said mixed liquor stream to dispose a layer of suspended solids at a vertical level of said clarifier; discharging waste water that has passed through said suspended solids layer as treated waste water effluent, and wherein optionally, said conveying step is actuated by gravitational potential energy.

7. (canceled)

8. The process of claim 6, further comprising periodically discharging at least a fraction of suspended solids in the clarifier and optionally recycling said discharged suspended solids to step a).

9. (canceled)

10. The process of claim 1, wherein said diatomite treatment agent is added to said mixed liquor stream upstream of said separating step.

11. The process of claim 1, wherein the pre-treatment process further comprises:
separating diatomite cells from said slurry by gravitational separation to form said diatomite treatment agent.

12. The process of claim 11, wherein said pre-treatment process further comprises a step of sonicating said slurry during the separation step and/or a step of applying an electric field to said slurry during said separation step.

13. (canceled)

14. A system for treatment of waste water, the system comprising:
at least one biological treatment zone configured to receive and contact waste water with microbes to thereby form a mixed liquor stream comprising activated sludge;
a clarifier in fluid communication with said biological treatment zone and configured to receive said mixed liquor stream from said biological treatment zone;
an inlet means disposed upstream of said clarifier operable to introduce a diatomite treatment agent to said mixed liquor stream;
wherein optionally, the flow velocity of the mixed liquor stream from the biological treatment zone is controllable;
wherein said diatomite treatment agent comprises 98 to 99.9% by weight of diatomite particles, said diatomite particles comprising unbalanced surface charges, and wherein said diatomite treatment agent is obtained from a pre-treatment process comprising: contacting crude diatomite with a treatment solution to form a slurry, the treatment solution comprising, based on the weight of the crude diatomite, about 0.03-0.05 wt. % of at least one xanthine derivative, about 0.1-0.2 wt. % of at least one metal metasilicate, about 0.025-0.05 wt. % of at least one metal phosphate, about 0.01-0.025 wt. % of at least one base and about 0.015-0.035 wt. % of at least one metal carbonate; and
an outlet means extending from said clarifier, being configured to discharge water that has been separated from the mixed liquor stream as treated waste water effluent.

15. The system of claim 14, wherein said diatomite treatment agent consists essentially of diatomite cells, said diatomite cells being substantially free of counter ions electrostatically coupled to its surface, and wherein optionally, each diatomite cell comprises a plurality of pores having an interior pore surface, the interior pore surface being substantially free of counter ions or charged impurities being electrostatically coupled thereto.

16. (canceled)

17. The system of claim 14, wherein said inlet means is configured to provide said diatomite treatment agent at about 10 milligrams to about 30 milligrams per litre of waste water.

18. The system of claim 14, wherein said diatomite treatment agent is substantially free of a flocculant or a coagulant.

19. The system of claim 14, wherein said clarifier is operated to suspend a solids layer within said clarifier, said suspended solids layer comprising biomass supported on said diatomite treatment agent.

20. The system of claim 19, wherein the clarifier comprises a zone for mixing said mixed liquor stream and said diatomite treatment agent to obtain a stream comprising the biomass/microbes supported on said diatomite treatment agent; wherein the clarifier further comprises a sedimentation zone, the sedimentation zone operated to suspend the solids layer therein.

21. (canceled)

22. The system of claim 19, wherein said outlet means is configured to discharge water that has passed through said suspended solids layer as effluent.

23. The system of claim 14, further comprising at least one conduit fluidly communicating said clarifier with said biological treatment zone, said conduit being operable to discharge at least a fraction of said suspended solids.

24. The system of claim 14, wherein the biological treatment zone is arranged to discharge said mixed liquor stream having higher gravitational potential energy relative to a mixed liquor stream that has been conveyed to said clarifier.

25. The system of claim 14, further comprising a dehydration zone configured to receive the mixed liquor stream comprising activated sludge that has been discharged from said clarifier and being operable to dehydrate the activated sludge without addition of flocculant or coagulant.

26. The system of claim 14, wherein said pre-treatment process comprises:
contacting crude diatomite with a treatment solution to form a slurry, the treatment solution comprising, based on the weight of the crude diatomite, about 0.03-0.05 wt. % of at least one xanthine derivative, about 0.1-0.2 wt. % of at least one metal metasilicate, about 0.025-0.05 wt. % of at least one metal phosphate, about 0.01-0.025 wt. % of at least one base and about 0.015-0.035 wt. % of at least one metal carbonate, and separating diatomite cells from said slurry by gravitational separation to form said diatomite treatment agent.
